(19) United States
(12) Patent Application Publication
(10) Pub. No.: US 2020/0012055 A1
(43) Pub. Date: Jan. 9, 2020

(54) BI-DIRECTIONAL OPTICAL SUB-ASSEMBLY, OPTICAL NETWORK UNIT, OPTICAL LINE TERMINAL, AND PASSIVE OPTICAL NETWORK SYSTEM

(71) Applicant: HUAWEI TECHNOLOGIES CO., LTD., Shenzhen (CN)

(72) Inventors: Zhicheng YE, Munich (DE); Jian CHEN, Wuhan (CN); Shengping LI, Wuhan (CN)

(73) Assignee: HUAWEI TECHNOLOGIES CO., LTD., Shenzhen (CN)

(21) Appl. No.: 16/572,729

(22) Filed: Sep. 17, 2019

Related U.S. Application Data
(63) Continuation of application No. PCT/CN2017/077856, filed on Mar. 23, 2017.

(51) Int. Cl. G02B 6/42; G02B 6/34; H04J 14/02; G02B 6/32; H04B 10/40; G02B 6/293

(52) U.S. Cl. CPC G02B 6/4214; G02B 6/34; H04J 14/02; G02B 6/2938; H04B 10/40; G02B 6/4215; G02B 6/32

(57) ABSTRACT

Embodiments relate to the field of optical communications technologies. The bi-directional optical sub-assembly includes a transmitter optical path sub-assembly, a receiver optical sub-assembly, a wavelength division multiplexing sub-assembly, and an optical fiber interface. The transmitter optical path sub-assembly is configured to: generate emitted light and provide the emitted light for the wavelength division multiplexing sub-assembly; the wavelength division multiplexing sub-assembly is configured to: transparently transmit, to the optical fiber interface, the emitted light from the transmitter optical path sub-assembly, and reflect, to the receiver optical sub-assembly, received light from the optical fiber interface; the optical fiber interface is configured to: transmit, to the outside, the emitted light from the wavelength division multiplexing sub-assembly, and transmit, to the wavelength division multiplexing sub-assembly, received light received from the outside; and the receiver optical sub-assembly is configured to receive the received light reflected by the wavelength division multiplexing sub-assembly.

### CROSS-REFERENCE TO RELATED APPLICATIONS

This application is a continuation of International Application No. PCT/CN2017/077856, filed on Mar. 23, 2017, the disclosure of which is hereby incorporated by reference in its entirety.

### FIELD

This application relates to the field of optical fiber communications technologies, and in particular, to a bi-directional optical sub-assembly, an optical network unit, an optical line terminal, and a passive optical network system.

### BACKGROUND

In a passive optical network (PON), a same optical fiber is used in upstream and downstream directions. In an existing PON, a bi-directional optical sub-assembly (BOSA) is usually used to implement single-fiber bi-direction communication. The BOSA integrates two sub-assemblies: a transmitter optical sub-assembly (TOSA) and a receiver optical sub-assembly (ROSA). A wavelength division multiplexing sub-assembly is disposed in each of the TOSA and the ROSA.

However, with constantly increasing bandwidth requirements for optical fiber access, an existing BOSA whose size is relatively large cannot meet a design requirement of a 50 G or 100 G Ethernet passive optical network (EPON) or the like.

### SUMMARY

To resolve a prior-art problem of a relatively large size of a BOSA, embodiments provide a BOSA, an optical network unit (ONU), an optical line terminal (OLT), and a passive optical network system. The technical solutions are as follows.

According to a first aspect, a BOSA is provided. The BOSA includes a transmitter optical path sub-assembly, a receiver optical sub-assembly, a wavelength division multiplexing sub-assembly, and an optical fiber interface, where

the transmitter optical path sub-assembly is configured to: generate emitted light and provide the emitted light for the wavelength division multiplexing sub-assembly;

the wavelength division multiplexing sub-assembly is configured to: transparently transmit, to the optical fiber interface, the emitted light from the transmitter optical path sub-assembly, and reflect, to the receiver optical sub-assembly, received light from the optical fiber interface;

the optical fiber interface is configured to: transmit, to the outside, the emitted light from the wavelength division multiplexing sub-assembly, and transmit, to the wavelength division multiplexing sub-assembly, received light received from the outside; and

the receiver optical sub-assembly is configured to receive the received light reflected by the wavelength division multiplexing sub-assembly.

The emitted light is light that is generated by the transmitter optical path sub-assembly in the BOSA and emitted to the outside. In some embodiments, there may be m paths of emitted light, where m is a positive integer, and each path of emitted light corresponds to one wavelength. For example, there are four paths of emitted light whose wavelengths are λ1, λ2, λ3, and λ4. Similarly, the received light is light that is received from the outside by the receiver optical sub-assembly in the BOSA. For example, there may be n paths of received light, and each path of received light corresponds to one wavelength. For example, there are four paths of received light whose wavelengths are λ5, λ6, λ7, and λ8. In addition, m and n may be the same or different. These are non-limiting examples.

The wavelength division multiplexing sub-assembly transparently transmits the emitted light from the transmitter optical path sub-assembly to the optical fiber interface, and reflects the received light from the optical fiber interface to the receiver optical sub-assembly. In such embodiments, the transmitter optical path sub-assembly and the receiver optical sub-assembly share one wavelength division multiplexing sub-assembly. This reduces a quantity of sub-assemblies in the BOSA, reduces a size of the BOSA, resolves a prior-art problem of a relatively large size of a BOSA that cannot meet a use requirement, and achieves an effect of reducing the size of the BOSA.

In a first possible implementation, the wavelength division multiplexing sub-assembly includes a receiving deflecting prism, and the receiving deflecting prism includes a first refraction surface, a first reflection surface, a second refraction surface, and a third refraction surface, where

the first refraction surface is disposed facing the transmitter optical path sub-assembly, a film is disposed on the first refraction surface, and the film is configured to fully transmit the emitted light and fully reflect the received light;

the first reflection surface is configured to reflect, to the third refraction surface, the received light reflected by the film;

the second refraction surface is disposed facing the optical fiber interface, and the second refraction surface is configured to: propagate, to the optical fiber interface, the emitted light transparently transmitted by the first refraction surface, and propagate, to the first refraction surface, the received light from the optical fiber interface; and

the third refraction surface is disposed facing the receiver optical sub-assembly, and the third refraction surface is configured to propagate, to the receiver optical sub-assembly, the received light reflected by the first refraction surface.

Due to the film disposed on the surface that faces the transmitter optical path sub-assembly and that is on the receiving deflecting prism fully transmits the emitted light and fully reflects the received light means that light whose wavelength is a wavelength of the emitted light can be transparently transmitted after passing through the film, and light whose wavelength is a wavelength of the received light is reflected by the film after passing through the film. For example, it is assumed that there are four paths of emitted light whose wavelengths are λ1, λ,2, λ3, and λ4, and there are four paths of received light whose wavelengths are λ5, λ6, λ7, and λ8. In this case, after light whose wavelengths are λ1, λ2, λ3, and λ4 passes through the film, the light can permeate the film and continue to be transmitted. By contrast, after light whose wavelengths are λ5, λ6, λ7, and λ8 passes through the film, the film reflects the light.

In an exemplary implementation, the film may be plated on the surface that faces the transmitter optical path sub-assembly and that is on the receiving deflecting prism, or may be painted on the surface that faces the transmitter optical path sub-assembly and that is on the receiving deflecting prism, or may be stuck to the surface that faces the transmitter optical path sub-assembly and that is on the receiving deflecting prism. These are non-limiting examples.

The film plated on the surface that faces the transmitter optical path sub-assembly and that is on the receiving deflecting prism fully transmits the emitted light and fully reflects the received light. In this way, both wavelength division multiplexing (WDM) of the emitted light and that of the received light are implemented by using the receiving deflecting prism in the wavelength division multiplexing sub-assembly, and WDM sub-assembly does not need to be separately disposed for the transmitter optical path sub-assembly and the receiver optical sub-assembly. This reduces the size of the BOSA.

With reference to the first possible implementation, in a second possible implementation, the receiver optical sub-assembly includes n receiving light-splitting films facing the third refraction surface, where

when i<n, an i^{th} receiving light-splitting film is configured to: transparently transmit one path of received light propagated by the third refraction surface, and reflect another path of received light to a second reflection surface on the receiving deflecting prism, and the second reflection surface is configured to: reflect the another path of received light, and propagate the another path of received light to an (i+1)^{th} receiving light-splitting film through the third refraction surface, where 1≤i≤n, and a first receiving light-splitting film is a film facing the transmitter optical path sub-assembly in the n receiving light-splitting films; or

when i=n, the i^{th} receiving light-splitting film is configured to transparently transmit one path of received light propagated by the third refraction surface.

In a third possible implementation, the wavelength division multiplexing sub-assembly includes a planar lightwave circuit (PLC).

In a fourth possible implementation, the wavelength division multiplexing sub-assembly includes n predisposed films disposed side by side; and each predisposed film is configured to transparently transmit the emitted light, where

when j<n, a j^{th} predisposed film is configured to: reflect one of various paths of received light to the receiver optical sub-assembly, and transparently transmit another path of received light to a (j+1)^{th} predisposed film, where 1≤j≤n, and a first predisposed film is a film facing the optical fiber interface in the n predisposed films; or

when j=n, the j^{th} predisposed film is configured to reflect, to the receiver optical sub-assembly, one path of received light transparently transmitted by a (j−1)^{th} predisposed film.

Each of the n predisposed films in the receiver optical sub-assembly reflects one path of received light and transparently transmits the emitted light and another path of received light. In this way, both WDM of the transmitter optical path sub-assembly and that of the receiver optical sub-assembly are implemented by using the n predisposed films, and WDM sub-assembly does not need to be separately disposed for the transmitter optical path sub-assembly and the receiver optical sub-assembly. This reduces the size of the BOSA.

With reference to the first possible implementation, the second possible implementation, the third possible implementation, and the fourth possible implementation, in a fifth possible implementation, the wavelength division multiplexing sub-assembly and the transmitter optical path sub-assembly are disposed side by side in a first direction, and the wavelength division multiplexing sub-assembly and the receiver optical sub-assembly are disposed side by side in a second direction, where the first direction is perpendicular to the second direction.

In a sixth possible implementation, the wavelength division multiplexing sub-assembly includes a first optical path deflecting component and a second optical path deflecting component, and the first optical path deflecting component is configured to: propagate the emitted light to the optical fiber interface, and propagate, to the receiver optical sub-assembly through the second optical path deflecting component, the received light received by the optical fiber interface.

With reference to the sixth possible implementation, in a seventh possible implementation, the first optical path deflecting component and the transmitter optical path sub-assembly are disposed side by side in a first direction, the second optical path deflecting component and the receiver optical sub-assembly are disposed side by side in the first direction, and the transmitter optical path sub-assembly and the receiver optical sub-assembly are disposed side by side in a second direction, where the second direction is perpendicular to the first direction.

With reference to any one of the first aspect and the various possible implementations of the first aspect, in an eighth possible implementation, the optical fiber interface may be a collimated optical receptacle. The collimated optical receptacle is used to improve transmitter and receiver coupling efficiency and improve receiver sensitivity.

In a ninth possible implementation, the transmitter optical path sub-assembly includes an optical path deflecting component, and the optical path deflecting component is a transmitting deflecting prism or a PLC.

According to a second aspect, an ONU is provided, where the ONU includes the BOSA according to the first aspect.

According to a third aspect, an OLT is provided, where the OLT includes the BOSA according to the first aspect.

According to a fourth aspect, a passive optical network system is provided, where the system may include an ONU and an OLT. The ONU may include the BOSA according to the first aspect; and/or the OLT includes the BOSA according to the first aspect.

### BRIEF DESCRIPTION OF DRAWINGS

FIG. 1 is a schematic diagram of an implementation environment related to a BOSA according to embodiments;

FIG. 2 is an architectural diagram of a 100 G EPON related to a BOSA according to embodiments;

FIG. 3 is a schematic diagram of a BOSA according to an embodiment;

FIG. 4 is a schematic diagram of a BOSA according to another embodiment;

FIG. 5 is a schematic diagram of a position relationship between a predisposed film and a receiver optical sub-assembly according to another embodiment;

FIG. 6 is a schematic diagram of a BOSA according to still another embodiment; and

FIG. 7, FIG. 8, and FIG. 9 each are a schematic diagram of a BOSA according to still another embodiment.

### DESCRIPTION OF EMBODIMENTS

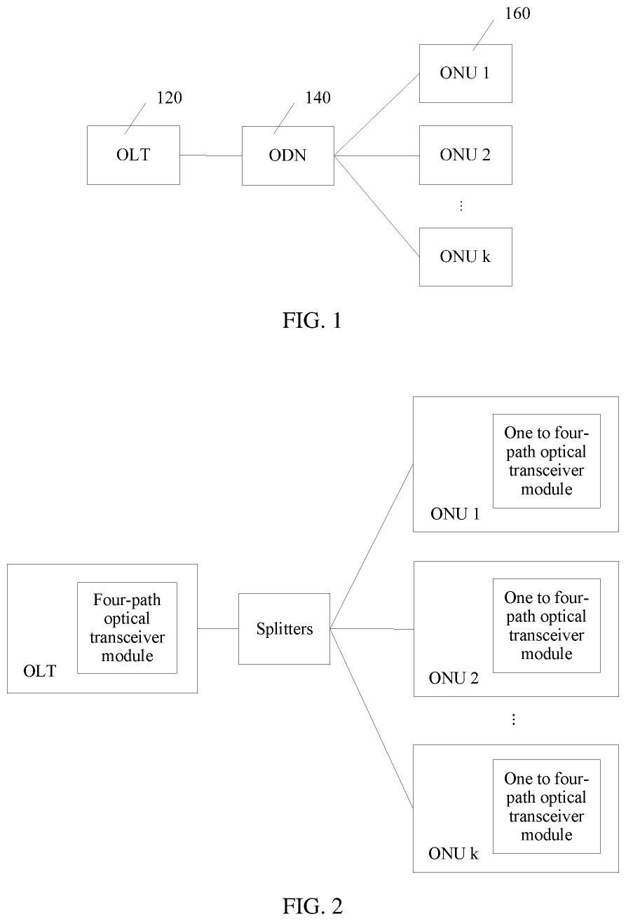

Referring to FIG. 1, an embodiment provides a passive optical network system. As shown in FIG. 1, the passive optical network system may include an OLT 120, an optical distribution network (ODN) 140, and an ONU 160.

The OLT 120 is a core part of an optical access network (OAN), and is a platform providing a number of services. In an implementation, the OLT 120 can be placed at a central office, and is configured to provide a network side interface of the OAN. Exemplary functions of the OLT 120 are as follows: first, connecting to an upper-layer network to complete upstream access of the PON network; second, connecting to the ONU 160 by using the ODN 140, to implement functions such as control, management, and ranging for the ONU 160. In an implementation, an optical module is disposed in the OLT 120. The optical module is configured to convert an electrical signal into an optical signal, to transmit the optical signal in an optical fiber.

The ODN 140 is an optical transmission medium connecting the OLT 120 to the ONU 160. In an implementation, the ODN 140 may include a passive component, for example, a splitter.

The ONU 160 is a user end device in the optical network. In an implementation, the ONU 160 may be placed at a user end, is configured to provide a user side interface of the OAN, and cooperates with the OLT 120 to implement Ethernet Layer 2 and Ethernet Layer 3 functions, to provide voice, data, and multimedia services for a user. In an implementation, an optical module is disposed in the ONU 160. The optical module is configured to convert an electrical signal into an optical signal, to transmit the optical signal in the optical fiber. In an implementation, there may be a plurality of ONUs 160. In FIG. 1, k ONUs are used as an example, where k is a positive integer.

The foregoing passive optical network may be an Ethernet passive optical network (EPON), a gigabit-capable passive optical network (GPON), an XG-PON, or the like. This is not limited in this embodiment. In addition, the optical module in the OLT 120 may include a bi-directional optical sub-assembly provided in the following embodiments, or the optical module in the ONU 160 includes a bi-directional optical sub-assembly provided in the following embodiments. For example, the optical module in the OLT 120 and the optical module in the ONU 160 each may further include a bi-directional optical sub-assembly provided in the following embodiments. This is not limited in this embodiment.

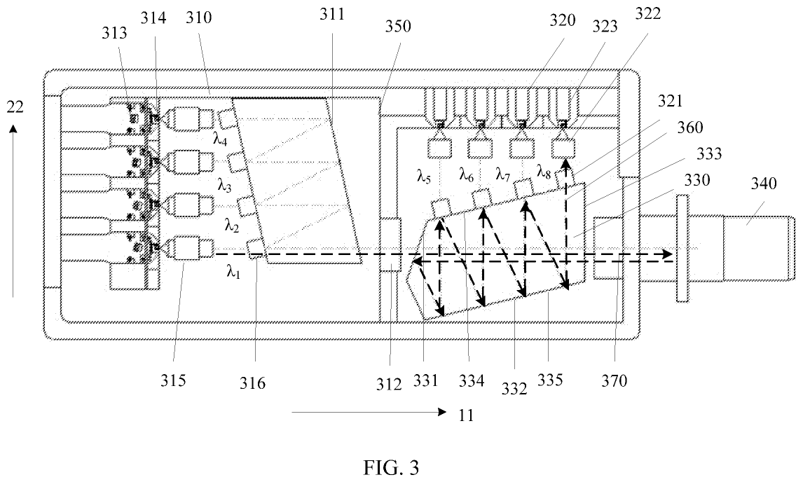

An example in which the passive optical network system is a 100 G EPON is used. FIG. 2 shows an architecture of the 100 G EPON. As shown in FIG. 2, if each path of an optical transceiver module implements a 25 G bandwidth, an OLT may include a four-path optical transceiver module. The four-path optical transceiver module may include a bi-directional optical sub-assembly implementation provided in the following embodiments. An ONU may have 25 G, 50 G, 100 G, or a larger rate based on a use requirement, that is, an optical transceiver module in the ONU may have one path, two paths, four paths, or more paths. When the optical transceiver module in the ONU has two paths, four paths, or more paths, the optical transceiver module may be implemented by using a bi-directional optical sub-assembly in the following embodiments.

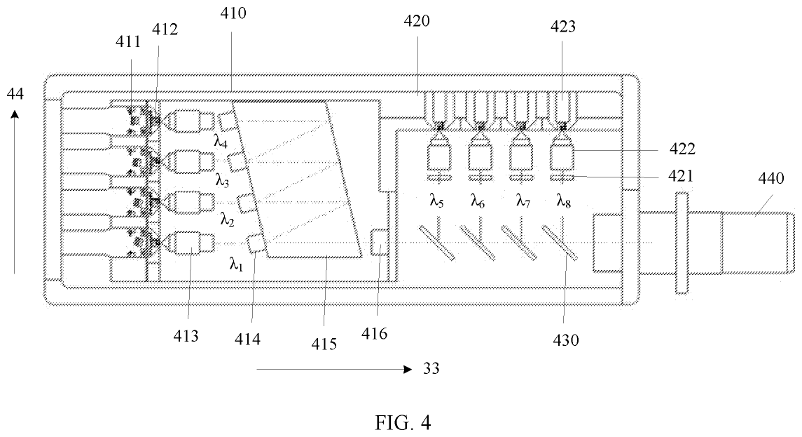

FIG. 3 is a schematic diagram of a bi-directional optical sub-assembly BOSA according to an embodiment. As shown in FIG. 3, the BOSA may include a transmitter optical path sub-assembly 310, a receiver optical sub-assembly 320, a wavelength division multiplexing sub-assembly 330, and an optical fiber interface 340.

As shown in FIG. 3, the transmitter optical path sub-assembly 310 and the receiver optical sub-assembly 320 are disposed side by side in a first direction 11. The wavelength division multiplexing sub-assembly 330 may be a receiving deflecting prism. As shown in FIG. 3, the receiving deflecting prism 330 and the transmitter optical path sub-assembly 310 are disposed side by side in the first direction 11, and the receiving deflecting prism 330 and the receiver optical sub-assembly 320 are disposed side by side in a second direction 22. The first direction 11 is perpendicular to the second direction 22. The being disposed side by side in this embodiment may be arrangement in parallel in a strict sense, that is, parallel objects are totally aligned; or may mean a crossing in the second direction. This is not limited in this embodiment.

The receiving deflecting prism 330 may receive emitted light generated and emitted by the transmitter optical path sub-assembly 310, and transmit the received emitted light to the outside through the optical fiber interface 340. In addition, the receiving deflecting prism 330 may further transmit, to the receiver optical sub-assembly 320, received light received from the outside by the optical fiber interface 340.

The receiving deflecting prism 330 is a three-dimensional prism. A shape and a structure of the receiving deflecting prism 330 are not limited in this embodiment. In addition, in an implementation, as shown in FIG. 3, the receiving deflecting prism 330 may include a first refraction surface 331, a first reflection surface 332, a second refraction surface 333, and a third refraction surface 334.

The first refraction surface 331 is disposed facing the transmitter optical path sub-assembly 310. A film is disposed on the first refraction surface 331. The film is configured to fully transmit the emitted light and fully reflect the received light. Optionally, the film may be plated on the first refraction surface 331, or may be painted on the first refraction surface 331, or may be stuck to the first refraction surface 331. This is not limited. In an implementation, the film covers the entire first refraction surface 331.

The film is configured to fully transmit the emitted light and fully reflect the received light. For example, when passing through the first refraction surface 331, the emitted light is directly transparently transmitted, and continues to be transmitted without changing a propagation direction of the light. However, when the received light passes through the first refraction surface 331, the received light is reflected. Consequently, a propagation direction of the received light is changed. Optionally, there may be m paths of emitted light generated by the transmitter optical path sub-assembly 310. Each path of emitted light corresponds to one wavelength. The film is configured to transparently transmit all emitted light with m wavelengths. Each path of emitted light may be transmitted by using one transmitting optical path (the transmitting optical path described in this embodiment is a complete optical path that starts from generation of the emitted light and ends with transmission of the emitted light to the outside through the optical fiber interface 340). There may be n paths of received light from the optical fiber interface 340. Each path of received light corresponds to one wavelength. The film is configured to reflect all received light with n wavelengths. Each path of received light is transmitted by using one receiving optical path (FIG. 3 schematically shows one receiving optical path 360 and one transmitting optical path 370.) In the foregoing, m and n are integers greater than 1, and values of m and n may be the same or different. For example, it is assumed that m=n=4, there are four paths of emitted light whose wavelengths are λ1, λ,2, λ3, and λ4, and there are four paths of received light whose wavelengths are λ5, λ6, λ7, and λ8. In this case, after light whose wavelengths are λ1, λ2, λ3, and λ4 passes through the film, the light can permeate the film and continue to be transmitted. By contrast, after light whose wavelengths are λ5, λ6, λ7, and λ8 passes through the film, the film reflects the light.

In an implementation, a material of the film may be selected based on wavelengths (for example, λ1, λ2, λ3, and λ4 mentioned above) of various paths of emitted light and wavelengths (for example, λ5, λ6, λ7, and λ8 mentioned above) of various paths of received light that are required by the BOSA for multiplexing. This is not limited in this embodiment.

The first reflection surface 332 is configured to reflect, to the third refraction surface 334, the received light reflected by the film. After the film disposed on the first refraction surface 331 reflects the received light, the received light is reflected by the first reflection surface 332 and arrives at the third refraction surface 334. The first reflection surface 332 in this embodiment is a generic term of all reflection surfaces used when the received light reflected by the first refraction surface 331 is reflected to the third refraction surface 334. In an implementation, the first reflection surface 332 may be one surface, or may be a plurality of surfaces. This is not limited in this embodiment.

The second refraction surface 333 is disposed facing the optical fiber interface 340. The second refraction surface 333 is configured to: propagate, to the optical fiber interface 340, the emitted light transparently transmitted by the first refraction surface 331; and propagate, to the first refraction surface 331, the received light from the optical fiber interface 340.

The third refraction surface 334 is disposed facing the receiver optical sub-assembly 320. The third refraction surface 334 is configured to propagate, to the receiver optical sub-assembly 320, the received light reflected by the first refraction surface 331.

Optionally, the transmitter optical path sub-assembly 310 may include a transmit end optical path deflecting component 311. The receiving deflecting prism 330 may face the transmit end optical path deflecting component 311. The transmit end optical path deflecting component 311 may be a transmitting deflecting prism or a planar lightwave circuit (PLC). In FIG. 3, an example in which the transmit end optical path deflecting component 311 is a transmitting deflecting prism is merely used for description. This is not limited in this embodiment. The PLC may be an arrayed waveguide grating (AWG), a Mach-Zehnder interferometer (MZI), a photonic crystal (PC), or the like. This is not limited in this embodiment either.

Optionally, the transmitter optical path sub-assembly 310 may further include an isolator 312. The isolator 312 is located between the transmit end optical path deflecting component 311 and the receiving deflecting prism 330, and the isolator 312 is configured to isolate light other than the emitted light in the BOSA. In an implementation, a spacer 350 may be disposed between the transmitter optical path sub-assembly 310 and the receiver optical sub-assembly 320 to avoid mutual interference between the emitted light and the received light. A gap that is used to transmit the emitted light to the receiving deflecting prism 330 is disposed in the spacer 350. The isolator 312 may be disposed at the gap. This is not limited in this embodiment.

The film is disposed on the first refraction surface 331 that is on the receiving deflecting prism 330 and that faces the transmitter optical path sub-assembly 310, and the film 332 fully transmits the emitted light. Therefore, after the transmitter optical path sub-assembly 310 emits the emitted light, the emitted light may pass through the receiving deflecting prism 330 and arrive at the optical fiber interface 340, and then is sent to the outside by the optical fiber interface 340. Similarly, the film fully reflects the received light. Therefore, after the optical fiber interface 340 receives the received light, the received light does not arrive at the transmitter optical path sub-assembly 310 through the receiving deflecting prism 330. This avoids interference in the transmitter optical path sub-assembly 310.

For example, in an implementation, the transmitter optical path sub-assembly 310 may further include another component. For example, referring to FIG. 3, the transmitter optical path sub-assembly 310 sequentially includes, in the first direction 11, m backlights 313 disposed side by side in the second direction 22, m transmitting tube cores 314 disposed side by side in the second direction 22, m transmitting converging lenses 315 disposed side by side in the second direction 22, m transmit end light-splitting films 316 disposed side by side in the second direction 22, and the like, where m is a quantity of paths of emitted light, and a value of m may be the same as or different from that of n. This is not limited in this embodiment.

The receiver optical sub-assembly 320 includes n receiving light-splitting films 321 facing the third refraction surface 334.

When i<n, an i^{th} receiving light-splitting film is configured to: transparently transmit one path of received light propagated by the third refraction surface 334, and reflect another path of received light to a second reflection surface 335 on the receiving deflecting prism 330. The second reflection surface 335 is configured to: reflect the another path of received light, and propagate the another path of received light to an (i+1)^{th} receiving light-splitting film through the third refraction surface 334, where 1≤i≤n, and a first receiving light-splitting film is a film facing the transmitter optical path sub-assembly 310 in the n receiving light-splitting films 321.

Because the first receiving light-splitting film faces the transmitter optical path sub-assembly 310, the first one of the n receiving light-splitting films first receives the received light reflected by the first refraction surface 331, transparently transmits one of the received paths of received light, reflects another path of received light to the receiving deflecting prism 330, and reflects the another path of received light to a second receiving light-splitting film by using the second reflection surface 335 on the receiving deflecting prism 330. Similarly, the second receiving light-splitting film transparently transmits one of the received paths of received light, reflects another path of received light to the receiving deflecting prism 330, and reflects the another path of received light to the third receiving light-splitting film by using the second reflection surface 335 on the receiving deflecting prism 330, and so on, until a last receiving light-splitting film receives a last path of received light. The second reflection surface 335 described in this embodiment is a surface that is configured to reflect, to a next receiving light-splitting film, received light reflected by a previous receiving light-splitting film on the receiving deflecting prism 330. In an implementation, there may be one or more second reflection surfaces 335. This is not limited in this embodiment. In addition, the second reflection surface 335 and the first reflection surface 332 may be a same reflection surface, or may be different reflection surfaces. This is not limited.

When i=n, the i^{th} receiving light-splitting film is configured to transparently transmit one path of received light propagated by the third refraction surface 334.

For example, referring to FIG. 3, n=4 and four receiving light-splitting films are sequentially the first receiving light-splitting film, the second receiving light-splitting film, the third receiving light-splitting film, and a fourth receiving light-splitting film from left to right. It is assumed that the receiving deflecting prism 330 is in a shape shown in FIG. 3, and the first receiving light-splitting film first receives the received light sent by the receiving deflecting prism 330. In this case, the first receiving light-splitting film may transparently transmit the received light whose wavelength is λ5 in the four paths of received light, reflect the received light whose wavelengths are λ6, λ7, and λ8, and reflect the received light whose wavelengths are λ6, λ7, and λ8 to the second reflection surface 335. The second reflection surface 335 reflects the received light whose wavelengths are λ6, λ7, and λ8 to the second receiving light-splitting film. The second receiving light-splitting film may transparently transmit the received light whose wavelength is λ6 in the three received paths of received light, that is, the received light whose wavelengths are λ6, λ7, and λ8, and reflect the received light whose wavelengths are λ7 and λ8 to the second reflection surface 335. The second reflection surface 335 reflects the received light whose wavelengths are λ7 and λ8 to the third receiving light-splitting film. Similarly, the third receiving light-splitting film may transparently transmit the received light whose wavelength is λ7 in the two received paths of received light, that is, the received light whose wavelengths are λ7 and λ8, and reflect the received light whose wavelength is λ8 to the second reflection surface 335. The second reflection surface 335 reflects the received light whose wavelength is λ8 to the fourth receiving light-splitting film. The fourth receiving light-splitting film may transparently transmit the received path of received light whose wavelength is λ8.

Optionally, the receiver optical sub-assembly 320 may further sequentially include, in the second direction 22, n converging lenses 322 disposed side by side in the first direction 11 and n receiving tube cores 323 disposed side by side in the first direction 11, where n is an integer greater than 1, and n indicates a quantity of paths of received light. In an implementation, the receiving tube core 323 may be an avalanche photodiode (APD) or a photodiode (PD). This is not limited in this embodiment.

The optical fiber interface 340 may be a collimated optical receptacle. In this case, the emitted light and the received light are transmitted in parallel in the optical fiber interface 340. The collimated optical receptacle is used to improve transmitter and receiver coupling efficiency and improve receiver sensitivity. In an implementation, the optical fiber interface 340 may be an SC receptacle (Square Connector Receptacle) or an LC receptacle (Little Connector Receptacle). This is not limited in this embodiment.

A first point that may be further noted is that the BOSA may further integrate a laser diode driver (LDD) chip. The LDD driver is configured to control the receiving tube core 323 and the transmitting tube core 314. Details are not described herein.

A second point that may be further noted is that, in an implementation, the BOSA may be packaged by using a quad small form-factor pluggable optical module 28 (QSFP 28). Steps of packaging the BOSA may include the following: (1) secure the receiving tube core, where an error of securing the receiving tube core may be less than 3 μm, for example 1 μm. (2) secure the receiving deflecting prism, and secure and adjust a component on a side in the first direction in the receiver optical sub-assembly. For example, with reference to FIG. 3, a receiving light-splitting film and a converging lens that correspond to λ5 in the receiver optical sub-assembly may be secured and adjusted to implement optical path coupling. (3) Secure and adjust a component on the other side in the first direction in the receiver optical sub-assembly. For example, a receiving light-splitting film and a converging lens that correspond to λ8 are secured and adjusted to implement optical path coupling. (4) Secure and adjust various paths of components located between the two sides of secured components in the receiver optical sub-assembly, to implement optical path coupling. (5) Secure the transmitting tube core in the transmitter optical path sub-assembly, and secure and adjust a path of a component (that is, a component that transmits a path of emitted light that is not reflected by the transmitting deflecting prism) that is adjacent to the receiving deflecting prism and that is in the transmitter optical path sub-assembly, for example, secure a component corresponding to λ1 in FIG. 3, to implement parallel light coupling. (6) Secure and adjust a path of a component that is away from a secured component in the second direction in the transmitter optical path sub-assembly, for example, secure a component corresponding to λ4 in FIG. 3, to implement optical path coupling. (7) Secure the transmitting deflecting prism, and secure several other paths of components. Both the transmitter optical path sub-assembly and the receiver optical sub-assembly are secured to a flexible printed circuit (FPC) board, and the FPC on which the receiver optical sub-assembly is located bends in a direction opposite to a surface on which a secured component is located. This is not limited in this embodiment.

It can be further noted that, an example in which the transmitter optical path sub-assembly and the receiver optical sub-assembly are structures shown in the figure is merely used in FIG. 3. In an implementation, the receiver optical sub-assembly may be alternatively rotated clockwise by 180°. In this case, the transmit end optical path deflecting component in the transmitter optical path sub-assembly is also correspondingly rotated clockwise by 180°. This is not limited in this embodiment.

In this embodiment, an example in which the wavelength division multiplexing sub-assembly 330 is the receiving deflecting prism is merely used. In an implementation, the wavelength division multiplexing sub-assembly 330 may be alternatively a PLC. This is not limited in this embodiment.

Thus, according to the BOSA provided in this embodiment, the wavelength division multiplexing sub-assembly transparently transmits the emitted light from the transmitter optical path sub-assembly to the optical fiber interface, and reflects the received light from the optical fiber interface to the receiver optical sub-assembly. That is, the transmitter optical path sub-assembly and the receiver optical sub-assembly share one wavelength division multiplexing sub-assembly. This reduces a quantity of sub-assemblies in the BOSA, reduces a size of the BOSA, resolves a prior-art problem of a relatively large size of a BOSA that cannot meet a use requirement, and achieves an effect of reducing the size of the BOSA. In addition, sub-assemblies in the ROSA and the TOSA are separately disposed, so that the sub-assemblies in the BOSA are arranged more compactly. This further reduces the size of the BOSA.

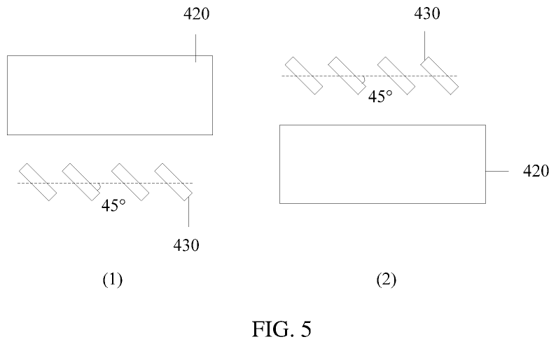

FIG. 4 is a schematic diagram of a BOSA according to another embodiment. As shown in FIG. 4, the BOSA includes a transmitter optical path sub-assembly 410, a receiver optical sub-assembly 420, a wavelength division multiplexing sub-assembly 430, and an optical fiber interface 440.

The wavelength division multiplexing sub-assembly 430 includes n predisposed films. The n predisposed films 430 are disposed in parallel in a first direction 33. In addition, the n predisposed films 430 are disposed side by side with the transmitter optical path sub-assembly 410 in the first direction, and are disposed side by side with the receiver optical sub-assembly 420 in a second direction 44, where n is an integer greater than 1, n indicates a quantity of paths of received light, and the first direction 33 is perpendicular to the second direction 44. The transmitter optical path sub-assembly 410 may be disposed side by side with the receiver optical sub-assembly 420 in the first direction 33, to reduce a volume of the BOSA.

In this embodiment, a structure of the transmitter optical path sub-assembly 410 is similar to the structure of the transmitter optical path sub-assembly in the foregoing embodiment. For example, referring to FIG. 4, the transmitter optical path sub-assembly 410 sequentially includes, in the first direction 33, m backlights 411 disposed side by side in the second direction 44, m transmitting tube cores 412 disposed side by side in the second direction 44, m transmitting converging lenses 413 disposed side by side in the second direction 44, m transmit end light-splitting films 414 disposed side by side in the second direction 44, a transmit end optical path deflecting component 415, an isolator 416, and the like, where m indicates a quantity of paths of emitted light. A structure of the receiver optical sub-assembly 420 is similar to the structure of the receiver optical sub-assembly in the foregoing embodiment. For example, the receiver optical sub-assembly 420 sequentially includes, in the second direction 44, n receiving light-splitting films 421 disposed side by side in the first direction 33, n converging lenses 422 disposed side by side in the first direction 33, and n receiving tube cores 423 disposed side by side in the first direction 33, where n is an integer greater than 1, and n indicates a quantity of paths of received light. However, in this embodiment, the wavelength division multiplexing sub-assembly 430 uses the n predisposed films 430 instead of a receiving deflecting prism. Each of the n predisposed films 430 is configured to transparently transmit emitted light.

When j<n, a j^{th} predisposed film is configured to: reflect one of various paths of received light to the receiver optical sub-assembly 420, and transparently transmit another path of received light to a (j+1)^{th} predisposed film, where 1≤j≤n, and a first predisposed film is a film facing the optical fiber interface 440 in the n predisposed films.

In an implementation, the n predisposed films 430 are disposed side by side with the optical fiber interface 440 in the first direction 33, and the first predisposed film faces the optical fiber interface 440. Therefore, after the optical fiber interface 440 receives the received light, the first predisposed film first receives the received light propagated by the optical fiber interface 440, reflects one of the received paths of received light, and transparently transmits another path of received light to a second predisposed film. Similarly, the second predisposed film reflects one of the received paths of received light, and transparently transmits another path of received light to a third predisposed film, and so on, until an n^{th} predisposed film receives a last path of received light.

When j=n, the j^{th} predisposed film is configured to reflect, to the receiver optical sub-assembly 420, one path of received light transparently transmitted by a (j−1)^{th} predisposed film.

For example, n=4. Referring to FIG. 4, it is assumed that a predisposed film closest to the optical fiber interface 440 in four predisposed films is the first predisposed film, and the following are sequentially the second predisposed film, the third predisposed film, and a fourth predisposed film from right to left. In this case, the first predisposed film reflects λ8, and transparently transmits λtx, λ5, λ6, and λ7. The second predisposed film reflects λ8, and transparently transmits λtx,λ5, and λ6. The third predisposed film reflects λ6, and transparently transmits λtx and λ5. The fourth predisposed film reflects λ5, and transparently transmits λtx, where λtx indicates various paths of emitted light, for example, λ1, λ2, λ3, and λ4 shown in FIG. 4.

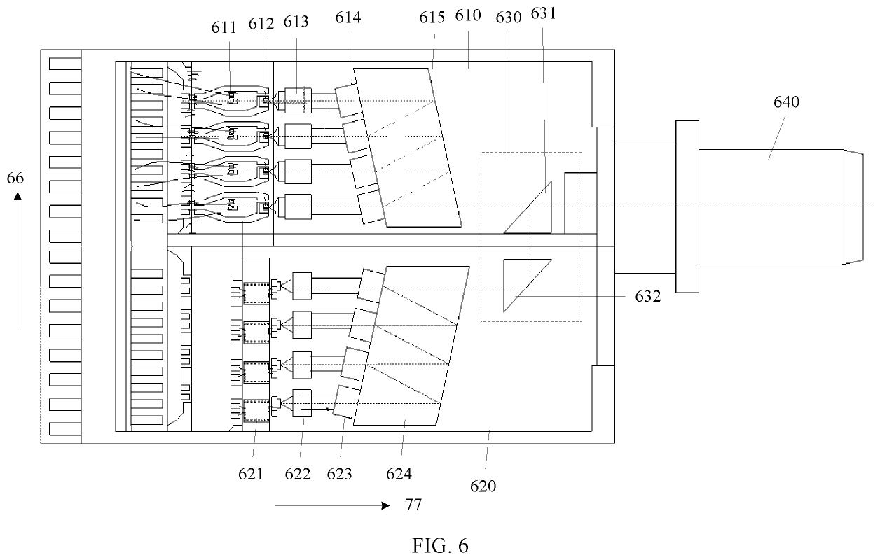

Each of the n predisposed films 430 may reflect, to the receiver optical sub-assembly 420, received light that can be reflected, and transparently transmit, to another component, light that can be transparently transmitted. A structure of the predisposed films 430 is not limited in this embodiment. For example, FIG. 1) and FIG. 2) in FIG. 5 respectively show a position relationship of the n predisposed films 430 when the receiver optical sub-assembly 420 is located above the n predisposed films 430 in a top view and a position relationship of the n predisposed films 430 when the receiver optical sub-assembly 420 is located below the n predisposed films 430 in a top view.

After the transmitter optical path sub-assembly 410 emits the emitted light, because the n predisposed films 430 transparently transmit the emitted light, the emitted light may arrive at the optical fiber interface 440 through the n predisposed films 430, and then be sent to the outside. After the optical fiber interface 440 receives the received light, with reference to FIG. 4, the first predisposed film reflects received light whose wavelength is λ8 in four paths of received light, that is, transmits the received light to the converging lens 422, where the received light arrives at the receiving tube core 423; and transparently transmits received light whose wavelengths are λ5, λ6, and λ7 to the second predisposed film. The second predisposed film reflects the received light whose wavelength is λ7, where the received light finally arrives at the receiving tube core 423; and transparently transmits the received light whose wavelengths are λ5 and λ6 to the third predisposed film. The third predisposed film reflects the received light whose wavelength is λ6, where the received light finally arrives at the receiving tube core 423; and transparently transmits the received light whose wavelength is λ5 to the fourth predisposed film. The fourth predisposed film reflects the received light whose wavelength is λ5, where the received light arrives at the receiving tube core 423. In an implementation, the transmitter optical path sub-assembly 410 may include the isolator adjacent to the n predisposed films 430. The isolator is configured to isolate light other than the emitted light in the BOSA.

In this embodiment, the optical fiber interface 440 may be a collimated optical receptacle. In this case, the emitted light and the received light are transmitted in parallel in the optical fiber interface 440. The collimated optical receptacle is used to improve transmitter and receiver coupling efficiency and improve receiver sensitivity. In an implementation, the optical fiber interface 440 may be an SC receptacle or an LC receptacle. This is not limited.

In an implementation, the BOSA may be packaged by using a QSFP 28. Packaging steps are as follows: (1) secure the receiving tube core; (2) Secure and adjust the j^{th} predisposed film, a receiving light-splitting film disposed side by side with the j^{th} predisposed film in the second direction, and a converging lens, where 1≤j≤n, and a start value of j is 1. (3) When j<n, j+1 is performed, step (2) is performed again. When j=n, step (4) is performed. (4) Secure the transmitting tube core, and secure and adjust a path of a component (that is, a path of a component that transmits received light that is not reflected by the transmitting deflecting prism) adjacent to an n^{th} predisposed film, to implement parallel light coupling. (5) Secure and adjust a path of a component that is away from a secured component in the second direction in the transmitter optical path sub-assembly, to implement optical path coupling. (6) Secure the transmitting deflecting prism, and secure several other paths of components.

It can be noted that, similar to the foregoing embodiment, in this embodiment, the receiver optical sub-assembly 420 may be rotated clockwise by 180°. Correspondingly, the transmitting deflecting prism in the transmitter optical path sub-assembly 410 may also be rotated clockwise by 180°. Details are not described herein.

Thus, according to the BOSA provided in this embodiment, the wavelength division multiplexing sub-assembly transparently transmits the emitted light from the transmitter optical path sub-assembly to the optical fiber interface, and reflects the received light from the optical fiber interface to the receiver optical sub-assembly. That is, the transmitter optical path sub-assembly and the receiver optical sub-assembly share one wavelength division multiplexing sub-assembly. This reduces a quantity of sub-assemblies in the BOSA, reduces a size of the BOSA, resolves a prior-art problem of a relatively large size of a BOSA that cannot meet a use requirement, and achieves an effect of reducing the size of the BOSA. In addition, sub-assemblies in the ROSA and the TOSA are separately disposed, so that the sub-assemblies in the BOSA are arranged more compactly. This further reduces the size of the BOSA.

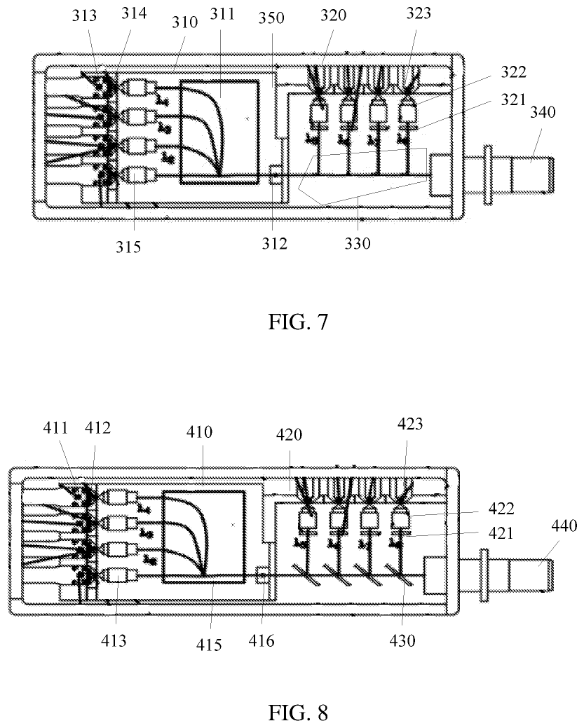

Referring to FIG. 6, FIG. 6 shows a schematic diagram of a BOSA according to still another embodiment. As shown in FIG. 6, the BOSA includes a transmitter optical path sub-assembly 610, a receiver optical sub-assembly 620, a wavelength division multiplexing sub-assembly 630, and an optical fiber interface 640.

The transmitter optical path sub-assembly 610 and the receiver optical sub-assembly 620 are disposed side by side in a first direction 66. For example, referring to FIG. 6, the transmitter optical path sub-assembly 610 and the receiver optical sub-assembly 620 may be vertically disposed. Optionally, each component in the transmitter optical path sub-assembly 610 may be disposed side by side in a second direction 77. For example, the transmitter optical path sub-assembly 610 sequentially includes, in the second direction 77, m backlights 611 disposed side by side in the first direction 66, m transmitting tube cores 612 disposed side by side in the first direction 66, m transmitting converging lenses 613 disposed side by side in the first direction 66, m transmitting light-splitting films 614 disposed side by side in the first direction 66, and a transmit end optical path deflecting component 615, where m indicates a quantity of paths of emitted light. Similarly, each component in the receiver optical sub-assembly 620 may be disposed side by side in the second direction 77. For example, the receiver optical sub-assembly 620 sequentially includes, in the second direction 77, n receiving tube cores 621 disposed side by side in the first direction 44, n receiving converging lenses 622 disposed side by side in the first direction 66, n receiving light-splitting films 623 disposed side by side in the first direction 66, and a receiving deflecting prism 624, where n indicates a quantity of paths of received light, and n is an integer greater than or equal to 2. In an implementation, m and n may be the same or different. This is not limited in this embodiment.

The transmitter optical path sub-assembly 610 may be disposed side by side with the optical fiber interface 640 in the second direction 77.

In an implementation, the wavelength division multiplexing sub-assembly 630 includes a first optical path deflecting component 631 and a second optical path deflecting component 632. The first optical path deflecting component 631 and the transmitter optical path sub-assembly 610 are disposed side by side in the second direction 77. The first optical path deflecting component 631 is adjacent to the optical fiber interface 640. The second optical path deflecting component 632 and the receiver optical sub-assembly 620 are disposed side by side in the second direction 77. The first optical path deflecting component 631 is configured to: transmit, to the optical fiber interface 640, the emitted light emitted by the transmitter optical path sub-assembly 610, to send the emitted light to the outside. Optionally, the first optical path deflecting component 631 is further configured to transmit, to the receiver optical sub-assembly 620 through the second optical path deflecting component 632, the received light received by the optical fiber interface 640. The second optical path deflecting component 632 is configured to transmit, to the receiver optical sub-assembly 620, the received light reflected by the first optical path deflecting component 631.

The first optical path deflecting component 631 may be a 45° light-splitting prism or a 45° light-splitting film. The second optical path deflecting component 632 may be a deflecting prism or a deflecting film. This is not limited. The second optical path deflecting component 632 may be adjacent to the first optical path deflecting component 631, or may be disposed away from the first optical path deflecting component 631. This is not limited in this embodiment. In addition, in an implementation, a direction for disposing the second optical path deflecting component 632 varies with a position for disposing the receiving deflecting prism. A based principle is that the second optical path deflecting component 632 can send, to the receiving deflecting prism, the received light transmitted by the first optical path deflecting component 631, and then the receiving deflecting prism sends the received light to each receiving tube core.

In an implementation, the BOSA may be packaged by using a QSFP 28. Packaging steps are as follows: (1) secure the first optical path deflecting component and the second optical path deflecting component. (2) Secure the receiving tube core. (3) Secure the receiving deflecting prism, and secure and adjust a path of a component (that is, a component that receives a path of received light that is not reflected by the receiving deflecting prism) adjacent to the second optical path deflecting component in the receiver optical sub-assembly. (4) Secure and adjust a path of a component that is away from a secured component in the first direction in the receiver optical sub-assembly. (5) Secure and adjust, in sequence, various paths of components located between the two paths of secured components in the receiver optical sub-assembly. (6) Secure the transmitting tube core, and secure and adjust a path of a component (that is, a path of a component that transmits the emitted light that is not reflected by the transmitting deflecting prism) adjacent to the first optical path deflecting component in the transmitter optical path sub-assembly, to implement parallel light coupling. (7) Secure and adjust a path of a component that is away from a secured component in the first direction in the transmitter optical path sub-assembly, to implement optical path coupling. (8) Secure the transmitting deflecting prism, and secure several other paths of components.

Therefore, according to the BOSA provided in this embodiment, the wavelength division multiplexing sub-assembly transparently transmits the emitted light from the transmitter optical path sub-assembly to the optical fiber interface, and reflects the received light from the optical fiber interface to the receiver optical sub-assembly. That is, the transmitter optical path sub-assembly and the receiver optical sub-assembly share one wavelength division multiplexing sub-assembly. This reduces a quantity of sub-assemblies in the BOSA, reduces a size of the BOSA, resolves a prior-art problem of a relatively large size of a BOSA that cannot meet a use requirement, and achieves an effect of reducing the size of the BOSA. In addition, sub-assemblies in the ROSA and the TOSA are separately disposed, so that the sub-assemblies in the BOSA are arranged more compactly. This further reduces the size of the BOSA.

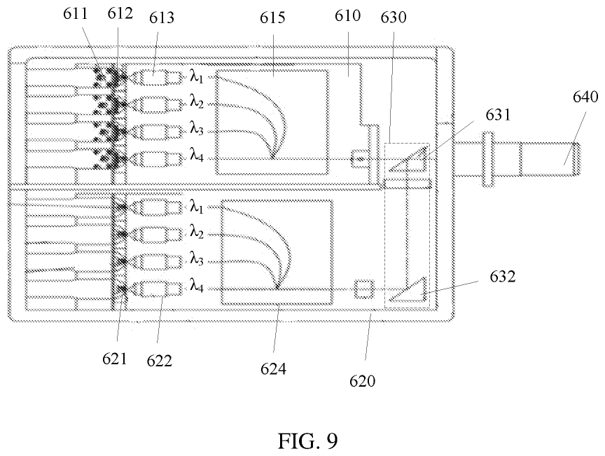

An example in which a transmit end optical path deflecting component is a transmitting deflecting prism is used in FIG. 3, FIG. 4, and FIG. 6. Optionally, referring to FIG. 7, FIG. 8, and FIG. 9, the transmit end optical path deflecting component may be alternatively a PLC. In addition, as shown in the figures, when the transmit end optical path deflecting component is the PLC, the transmitter optical path sub-assembly may not include a transmit end light-splitting film. Details are not described herein in this embodiment.

The foregoing descriptions are merely exemplary implementations of this application, but are not intended to limit the scope of this application. Any variation or replacement readily figured out by a person of ordinary skill in the art within the technical scope disclosed in this application shall fall within the protection scope of this application.

1. A bi-directional optical sub-assembly, comprising a transmitter optical path sub-assembly, a receiver optical sub-assembly, a wavelength division multiplexing sub-assembly, and an optical fiber interface, wherein
the transmitter optical path sub-assembly is configured to: generate emitted light and provide the emitted light for the wavelength division multiplexing sub-assembly;
the wavelength division multiplexing sub-assembly is configured to: transparently transmit, to the optical fiber interface, the emitted light from the transmitter optical path sub-assembly, and reflect, to the receiver optical sub-assembly, received light from the optical fiber interface;
the optical fiber interface is configured to: transmit, to the an outside, the emitted light from the wavelength division multiplexing sub-assembly, and transmit, to the wavelength division multiplexing sub-assembly, received light received from the outside; and
the receiver optical sub-assembly is configured to receive the received light reflected by the wavelength division multiplexing sub-assembly.

2. The bi-directional optical sub-assembly according to claim 1, wherein the wavelength division multiplexing sub-assembly comprises a receiving deflecting prism, and the receiving deflecting prism comprises a first refraction surface, a first reflection surface, a second refraction surface, and a third refraction surface, wherein
the first refraction surface is disposed facing the transmitter optical path sub-assembly, a film is disposed on the first refraction surface, and the film is configured to fully transmit the emitted light and fully reflect the received light;
the first reflection surface is configured to reflect, to the third refraction surface, the received light reflected by the film;
the second refraction surface is disposed facing the optical fiber interface, and the second refraction surface is configured to: transmit, to the optical fiber interface, the emitted light transparently transmitted by the first refraction surface, and propagate, to the first refraction surface, the received light from the optical fiber interface; and
the third refraction surface is disposed facing the receiver optical sub-assembly, and the third refraction surface is configured to propagate, to the receiver optical sub-assembly, the received light reflected by the first refraction surface.

3. The bi-directional optical sub-assembly according to claim 2, wherein the receiver optical sub-assembly comprises n receiving light-splitting films facing the third refraction surface, n is a quantity of paths of received light, and n≥2, wherein
when i<n, an i^{th} receiving light-splitting film is configured to: transparently transmit one path of received light propagated by the third refraction surface, and reflect another path of received light to a second reflection surface on the receiving deflecting prism, and the second reflection surface is configured to: reflect the another path of received light, and propagate the another path of received light to an (i+1)^{th} receiving light-splitting film through the third refraction surface, wherein 1≤i≤n, and a first receiving light-splitting film is a film facing the transmitter optical path sub-assembly in the n receiving light-splitting films; or when i=n, the i^{th} receiving light-splitting film is configured to transparently transmit one path of received light propagated by the third refraction surface.

4. The bi-directional optical sub-assembly according to claim 1, wherein the wavelength division multiplexing sub-assembly comprises a planar lightwave circuit.

5. The bi-directional optical sub-assembly according to claim 1, wherein the wavelength division multiplexing sub-assembly comprises n predisposed films disposed side by side, n is a quantity of paths of received light, and n≥2; and each predisposed film is configured to transparently transmit the emitted light, wherein
when j<n, a j^{th} predisposed film is configured to: reflect one of various paths of received light to the receiver optical sub-assembly, and transparently transmit another path of received light to a (j+1)^{th} predisposed film, wherein 1≤j≤n, and a first predisposed film is a film facing the optical fiber interface in the n predisposed films; or
when j=n, the j^{th} predisposed film is configured to reflect, to the receiver optical sub-assembly, one path of received light transparently transmitted by a (j−1)^{th} predisposed film.

6. The bi-directional optical sub-assembly according to claim 2, wherein the wavelength division multiplexing sub-assembly and the transmitter optical path sub-assembly are disposed side by side in a first direction, and the wavelength division multiplexing sub-assembly and the receiver optical sub-assembly are disposed side by side in a second direction, wherein the first direction is perpendicular to the second direction.

7. The bi-directional optical sub-assembly according to claim 1, wherein the wavelength division multiplexing sub-assembly comprises a first optical path deflecting component and a second optical path deflecting component, and the first optical path deflecting component is configured to: propagate the emitted light to the optical fiber interface, and propagate, to the receiver optical sub-assembly through the second optical path deflecting component, the received light received by the optical fiber interface.

8. The bi-directional optical sub-assembly according to claim 7, wherein the first optical path deflecting component and the transmitter optical path sub-assembly are disposed side by side in a first direction, the second optical path deflecting component and the receiver optical sub-assembly are disposed side by side in the first direction, and the transmitter optical path sub-assembly and the receiver optical sub-assembly are disposed side by side in a second direction, wherein the second direction is perpendicular to the first direction.

9. An optical network unit, wherein the optical network unit comprises an bi-directional optical sub-assembly, the bi-directional optical sub-assembly further comprising a transmitter optical path sub-assembly, a receiver optical sub-assembly, a wavelength division multiplexing sub-assembly, and an optical fiber interface, wherein
the transmitter optical path sub-assembly is configured to: generate emitted light and provide the emitted light for the wavelength division multiplexing sub-assembly;
the wavelength division multiplexing sub-assembly is configured to: transparently transmit, to the optical fiber interface, the emitted light from the transmitter optical path sub-assembly, and reflect, to the receiver optical sub-assembly, received light from the optical fiber interface;
the optical fiber interface is configured to: transmit, to an outside, the emitted light from the wavelength division multiplexing sub-assembly, and transmit, to the wavelength division multiplexing sub-assembly, received light received from the outside; and
the receiver optical sub-assembly is configured to receive the received light reflected by the wavelength division multiplexing sub-assembly.

10. An optical line terminal, wherein the optical line terminal comprises an bi-directional optical sub-assembly, the bi-directional optical sub-assembly further comprising a transmitter optical path sub-assembly, a receiver optical sub-assembly, a wavelength division multiplexing sub-assembly, and an optical fiber interface, wherein
the transmitter optical path sub-assembly is configured to: generate emitted light and provide the emitted light for the wavelength division multiplexing sub-assembly;
the wavelength division multiplexing sub-assembly is configured to: transparently transmit, to the optical fiber interface, the emitted light from the transmitter optical path sub-assembly, and reflect, to the receiver optical sub-assembly, received light from the optical fiber interface;
the optical fiber interface is configured to: transmit, to an outside, the emitted light from the wavelength division multiplexing sub-assembly, and transmit, to the wavelength division multiplexing sub-assembly, received light received from the outside; and
the receiver optical sub-assembly is configured to receive the received light reflected by the wavelength division multiplexing sub-assembly.

11. (canceled)
